(19) United States
(12) Patent Application Publication
(10) Pub. No.: US 2007/0164848 A1
(43) Pub. Date: Jul. 19, 2007

(54) Locking and unlocking system for setting up unlocking condition and method thereof

(76) Inventor: Teyoung Kim, Busan-city (KR)

Correspondence Address: LADAS & PARRY, 26 WEST 61ST STREET, NEW YORK, NY, 10023, US

(21) Appl. No.: 11/355,827

(22) Filed: Feb. 16, 2006

(30) Foreign Application Priority Data
Jan. 17, 2006 (KR) 10-2006-0004951

(51) Int. Cl. G05B 19/00

(52) U.S. Cl. 340/5.73; 340/5.54

(57) ABSTRACT

A locking and unlocking system for setting up an unlocking system condition and a method are disclosed, in which a user can set up various unlocking conditions in addition to an unlocking signal. The locking and unlocking system comprises an input device which outputs a key control signal, a setting unlocking signal, a setting unlocking condition and an unlocking signal in accordance with a user's operation; a main control device which receives and stores a setting unlocking signal and a setting unlocking condition outputted from the input device, receives an unlocking signal from the input device and compares the received unlocking signal with the stored setting unlocking signal for thereby judging whether the unlocking signals have a coincidence, and when the unlocking signals have a coincidence, it is judged whether the setting unlocking condition is satisfied or not, and when the setting unlocking condition is satisfied, the main control device outputs a locking unlocking signal; a driving device which receives a locking unlocking signal from the main control device and unlocks the locked state; and a locking and unlocking device in which the locking and unlocking state is changed based on an operation of the driving device.

### BACKGROUND OF THE INVENTION

1. Field of the Invention

The present invention relates to a locking and unlocking system for setting up an unlocking condition and a method thereof, and in particular to a locking and unlocking system for setting up an unlocking condition and a method thereof in which a locked state is unlocked when an unlocking signal such as a password, etc. is matched or a certain unlocking condition set by a user is satisfied in such a manner that a user sets a certain unlocking condition such as a time condition or an input frequency (number) condition.

2. Description of the Background Art

Generally, a bank, a company, a home or a personal office is provided with a safe so as to store cash, valuables or security documents. The above safe includes a dual or triple locking and unlocking system for thereby effectively protecting cash or previous things or security documents from robbery.

The above safe is classified into a fireproof safe capable of protecting various important documents such as a banknote, a testament, an insurance document, a pension certificate, a registered seal document, securities, tax documents, passport, etc. from a fire, a super strong safe which is used for storing cash, precious metals, etc. and is capable of safely storing the safe from an external impact with a safe reliability being determined by the thickness of a steel plate of an inner wall and an internal filler of the same, a fireproof and super strong safe which has both a fireproof function and super storing reliability by additionally providing an inner safe in an outer safe, and a simple steel safe which does not have a fireproof function.

Recently, there are various kinds of safes such as an electronic opening and closing safe having an electronic circuit, a fingerprint recognition safe which adapts a fingerprint recognition function, and a special purpose safe which has advanced electric and electronic technologies.

However, the above safes are designed to be locked or unlocked upon inputting a password, key or fingerprint which is needed for unlocking the locking and unlocking system. With this construction, if a burglar forces an owner to unlock the safe by force, the owner should unlock the locking and unlocking system of the safe, so that the burglar steals the things stored in the safe.

In addition, the conventional locking and unlocking system is basically designed based on an unlocking signal system. If the unlocking signal code is decoded, the locking and unlocking system may be easily unlocked, so that the conventional locking and unlocking system has many problems in reliability.

### SUMMARY OF THE INVENTION

Accordingly, it is an object of the present invention to provide a locking and unlocking system for setting up an unlocking system condition and a method thereof which overcome the problems encountered in the conventional art.

It is another object of the present invention to provide a locking and unlocking system for setting up an unlocking system condition and a method thereof in which a user can set up various unlocking conditions in addition to an unlocking signal.

To achieve the above objects, there is provided a locking and unlocking system for setting up an unlocking condition which comprises an input device which outputs a key control signal, a setting unlocking signal, a setting unlocking condition and an unlocking signal in accordance with a user's operation; a main control device which receives and stores a setting unlocking signal and a setting unlocking condition outputted from the input device, receives an unlocking signal from the input device and compares the received unlocking signal with the stored setting unlocking signal for thereby judging whether the unlocking signals have a coincidence, and when the unlocking signals have a coincidence, it is judged whether the setting unlocking condition is satisfied or not, and when the setting unlocking condition is satisfied, the main control device outputs a locking unlocking signal; a driving device which receives a locking unlocking signal from the main control device and unlocks the locked state; and a locking and unlocking device in which the locking and unlocking state is changed based on an operation of the driving device.

To achieve the above objects, in a method of a locking and unlocking system having an input device and a locking and unlocking device, there is provided a method of a locking and unlocking system for setting up an unlocking condition which comprises a step (a) in which a setting unlocking signal and a setting unlocking condition inputted through the input device are received and stored; a step (b) in which the unlocking signal inputted through the input device is received and compared with the setting unlocking signal for thereby judging a coincidence between the signals; and a step (c) in which when the unlocking signal is coincided, it is judged whether the stored setting unlocking condition is satisfied or not, and when the setting unlocking condition is satisfied, the locked state of the locking and unlocking device is unlocked.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating a safe which adapts a locking and unlocking system for setting up an unlocking condition according to the present invention;

FIG. 2 is a block diagram of a locking and unlocking system for setting up an unlocking condition according to the present invention; and

FIG. 3 is a flow chart of an operation of a locking and unlocking system for setting up an unlocking condition according to the present invention.

### DETAILED DESCRIPTION OF THE PREFERRED EMBODIMENTS

A locking and unlocking system for setting up an unlocking condition according to the present invention will be described with reference to the accompanying drawings.

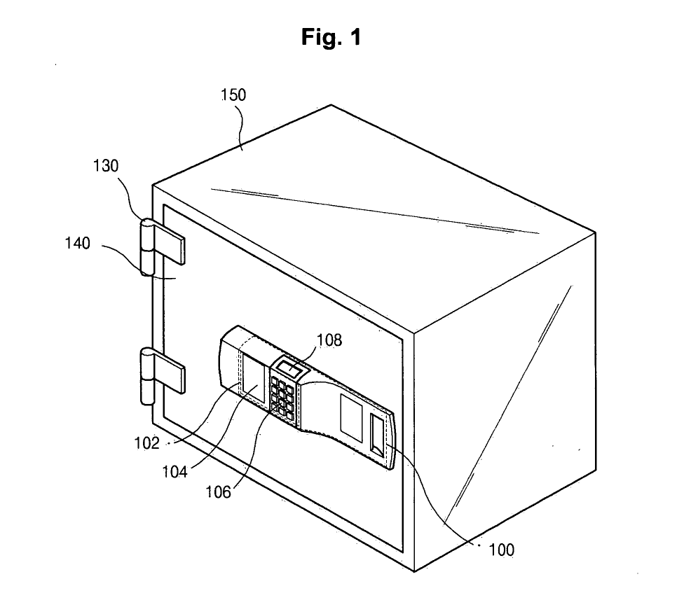

FIG. 1 is a view illustrating a safe which adapts a locking and unlocking system for setting up an unlocking condition according to the present invention.

As shown in FIG. 1, a safe provided with a locking and unlocking system for setting up an unlocking condition according to the present invention includes a safe body 150, a hinge 130, an opening and closing door 140, and an unlocking condition setting type locking and unlocking system 100.

Here, the unlocking condition setting type locking and unlocking system 100 is provided at the opening and closing door 140 installed at a front side of the safe body 150 and receives and stores a setting unlocking signal and a setting unlocking condition which are set by a user. In addition, the unlocking condition setting type locking and unlocking system 100 compares the unlocking signal inputted by the user with the stored setting unlocking signal when the mode is in the locking state. In the case that a coincidence of the unlocking signal is verified, it is judged whether the setting unlocking condition is satisfied or not. When the setting unlocking condition is satisfied, the locked state is unlocked.

The opening and closing 140 is operatively installed at the safe body 150 with the hinge 130 being disposed between the same. An opening and closing handle is installed at an inner side of the opening and closing door 140, so that the user can easily open or close the opening and closing door 140.

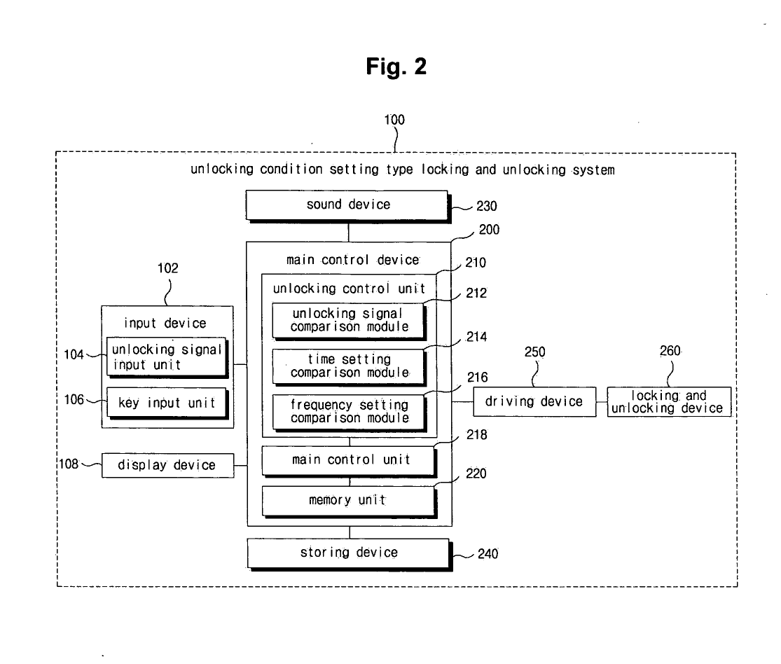

FIG. 2 is a block diagram of a locking and unlocking system for setting up an unlocking condition according to the present invention.

The locking and unlocking system for setting up an unlocking condition according to the present invention according to the present invention will be described with reference to the accompanying drawings.

As shown in FIG. 2, the locking and unlocking system for setting up an unlocking condition includes an input device 102, a main control device 200, a driving device 250 and a locking and unlocking device 260.

Here, the input device 102 outputs a key control signal, a setting unlocking signal, a setting unlocking condition and an unlocking signal in accordance with a user's operation. The input device 102 according to the present invention preferably includes a key input unit 106 for outputting a control signal based on a user's key input, and an unlocking signal input unit 104 for outputting an unlocking signal based on a user's operation.

The key input unit 106 may be formed of an ordinary key pad type input unit which has numeral keys and function keys and outputs a setting unlocking signal, a setting unlocking condition and various key control signals in accordance with a user's control.

The unlocking signal input unit 104 receives an inputting unlocking signal in accordance with a user's operation and outputs the same. Here, the unlocking signal input unit 104 and the key input unit 106 may be formed in one structure. Namely, in the case that the password inputted through the key input unit 106 is used as an unlocking signal, it does not need separately compose the unlocking signal input unit 104 and the key input unit 106. In the case that an additional recognition method such as a user identification card, iris recognition, etc. using a fingerprint recognition, RFID method local area wireless communication except for a password method through a key input is used as an unlocking signal, an unlocking signal input unit 104 such as a fingerprint recognition unit, a RFID communication unit, and an iris recognition unit which correspond to the above recognition methods may be separately provided. Since the unlocking signal input unit 104 may be implemented based on a known method, the detailed description of the same will be omitted.

The main control device 200 receives and stores the setting unlocking signal and setting unlocking condition outputted from the input device 102 and receives an unlocking signal from the input device 102 and compares the received signal with the set unlocking signal for thereby judging whether the unlocking signals are matched. In the case that the unlocking signals are matched, it is judged whether the previously stored setting locking condition is satisfied or not. When the setting unlocking condition is satisfied, the unlocking signal is outputted.

As the user inputs a desired setting unlocking signal and a setting unlocking condition by operating the input device 102, the main control device 200 receives the inputted signal and condition and performs a certain encryption process and stores a setting unlocking signal and a setting unlocking condition. When the data inputted as a setting unlocking signal is a password inputted using a keypad, a character information (including numeral information) is encrypted and stored. In the case that it is biological information such as a fingerprint, iris information, etc. except for the password, a specific feature of the same is searched and encrypted and stored. When a personal identification card is inputted as a setting unlocking signal using a local area wireless communication, a serial number of the local area wireless communication chip of the personal identification card is stored as a setting unlocking signal. The setting unlocking signal, which is inputted not through the encryption process, may be directly stored and used for judging the coincidence of the unlocking signal.

When the user inputs an unlocking signal through the input device 102 so as to unlock the locked state of the locking and unlocking device 260, the main control device 200 receives an inputting unlocking signal, encrypts the received unlocking signal using the same algorithm and extracts features for thereby judging the coincidence between the unlocking signal processed based on a certain algorithm and the stored setting unlocking signal. When the coincidence is verified, the satisfaction of the unlocking condition is judged. When the unlocking condition is satisfied, the locking unlocking signal is outputted.

More preferably, the main control device 200 according to the present invention includes a memory unit 220, an unlocking control unit 210 and a main control unit 218.

The memory unit 220 stores a setting unlocking signal and a setting unlocking condition outputted from the input device 102 and an operation program used for operating the locking and unlocking system. Here, the memory unit may be formed of an EEPROM (Electronically Erasable Programmable Read Only Memory) or a flash memory and may be formed of a RAM (Random Access Memory) as a temporary storing space of the data which are processed in real time. The operation program stored in the memory unit 220 controls the entire operations of the unlocking condition setting type unlocking and unlocking system 100. The above operation program may be periodically updated by the user. The setting unlocking signal and setting unlocking condition are stored in the memory unit 220 in accordance with the user's operation inputted from the input device 102.

The main control unit 218 controls the input device 102, the driving device 250, the memory unit 220 and the unlocking control unit 210 in accordance with the operation program stored in the memory unit 220 so that the unlocking condition setting type locking and unlocking system 100 according to the present invention operates.

The unlocking control unit 210 receives an unlocking signal from the input device 102 and compares with the setting unlocking signal stored in the memory unit 220 and judges the coincidence of the unlocking signals. When the unlocking signals are same, it is judged whether the setting unlocking condition stored in the memory unit 220 is satisfied or not. When the setting unlocking condition is satisfied, the locking unlocking signal is outputted.

The unlocking control unit 210 according to the present invention may preferably include an unlocking signal comparison module 212, a time setting comparison module 214 and a setting frequency comparison module 216.

The unlocking signal comparison module 212 receives an unlocking signal from the input device 102 and judges whether it is matched with the setting unlocking signal stored in the memory unit 220. When the setting unlocking signal is processed based on a certain algorithm and is stored, the unlocking signal comparison module 212 processes the unlocking signal inputted through the input device 102 based on the same algorithm and judges the coincidence with the setting unlocking signal.

When the coincidence of the unlocking signal is verified by the unlocking signal comparison module 212, and the unlocking time is set as the setting unlocking condition stored in the memory unit 220, the time setting comparison module 214 judges whether the unlocking signal inputted through the input device 102 is adapted to the unlocking signal or not. When the unlocking time is inputted, the locking unlocking signal is outputted. Namely, in the case that the user sets that the locked state of the locking and unlocking device 260 is unlocked only when the unlocking signal is inputted at 10 am, the time setting comparison module 214 judges the input time of the unlocking signal inputted by the user and maintains the locking state of the locking and unlocking device 260 when the current time is not 10 am. The locking unlocking signal is outputted so as to unlock the locked state of the locking and unlocking device 260 when the current time is 10 am. The above unlocking time may be set with accurate time system or may be set within a certain time range.

In addition, when the coincidence of the unlocking signal is verified by the unlocking signal comparison module 212, and the time lapse condition is set as the setting unlocking condition stored in the memory unit 220, the time setting comparison module 214 may be designed to output the locking unlocking signal after a standby time corresponding to the time lapse condition is passed. Namely, in the case that the user sets the locking and unlocking device 260 to be unlocked after 10 minutes since the user inputs an accurate unlocking signal, the time setting comparison module 214 outputs a locking unlocking signal at the time when 10 minutes has passed after the coincidence of the unlocking signal is verified by the unlocking signal comparison module 212.

So as to perform the above time condition comparison, the time setting comparison module 214 according to the present invention may be designed to measure accurate time by providing a time measuring module (not shown) in the interior of the same.

When the unlocking signal coincidence is verified by the unlocking signal comparison module 212, and the unlocking signal input frequency condition is set as the setting unlocking condition stored in the memory unit 220, the setting frequency comparison module 216 compares the input frequency of the unlocking signal inputted through the input device 102 with the unlocking signal input frequency condition. When the unlocking signal is inputted by the same frequency as the inputting frequency of the unlocking signal input frequency condition, the locking unlocking signal is outputted. Namely, when the user sets the locking state to be unlocked when the unlocking signal is inputted three times as the unlocking condition, the setting frequency comparison module 216 judges whether the verification of the unlocking signal is performed three times by the unlocking signal comparison module 212. When the verification is performed three times, the locking unlocking signal is outputted. In the case that an error unlocking signal is inputted through the verification process, the locking unlocking process stops. In this case, the user performs the locking unlocking process from the first stage.

The unlocking control unit 210 according to the present invention may be formed of at least one comparison module among the unlocking signal comparison module 212 for comparing the setting unlocking signal with the unlocking signal, the time setting comparison module 214 for a time lapse condition comparison, and the setting frequency comparison module 216 for the input frequency comparison. It may be constituted so that one time setting comparison module 214 performs an unlocking time condition comparison and a time lapse condition comparison.

The driving device 250 receives a locking unlocking signal outputted from the main control device 200 and unlocks the locked state. The locking and unlocking device 260 changes the locking and unlocking state based on the operation of the driving device 250. The driving device 250 and the locking and unlocking device 260 may be formed of known various driving devices and locking and unlocking devices.

As shown in FIG. 2, the unlocking condition setting type locking and unlocking system 100 according to the present invention may further include a display device 108, a sound device 230 and a storing device 240.

Here, the display device 108 displays the operation states in accordance with a control of the main control device 200. The display device 108 may be formed of a LED or a LCD. The display device 108 may be designed to display various menu, information and operation states so as to effectively operate the unlocking condition setting type locking and unlocking system 100 according to the present invention.

The sound device 230 outputs a sound guide information, operation sound and alarm sound in accordance with a control of the main control device 200. A robbery prevention function may be performed based on a user's setting. When the unlocking signal is not matched or the unlocking condition is not matched, the alarm sound may be outputted.

The storing device 240 stores various operation programs and various data needed for a locked state unlocking operation which are used in the unlocking condition setting type locking and unlocking system 100 according to the present invention. The time and information based on the locked state unlocking operation are stored as a log file format. So, the user can confirm the log file and check that the locked state of the locking and unlocking device 260 is unlocked by what method.

The unlocking condition setting type locking and unlocking system according to the present invention has been described with an example adapted to the safe. However, it is obvious that the unlocking condition setting type locking and unlocking system according to the present invention can be adapted to various item locking and unlocking systems including a gift box except for the safe.

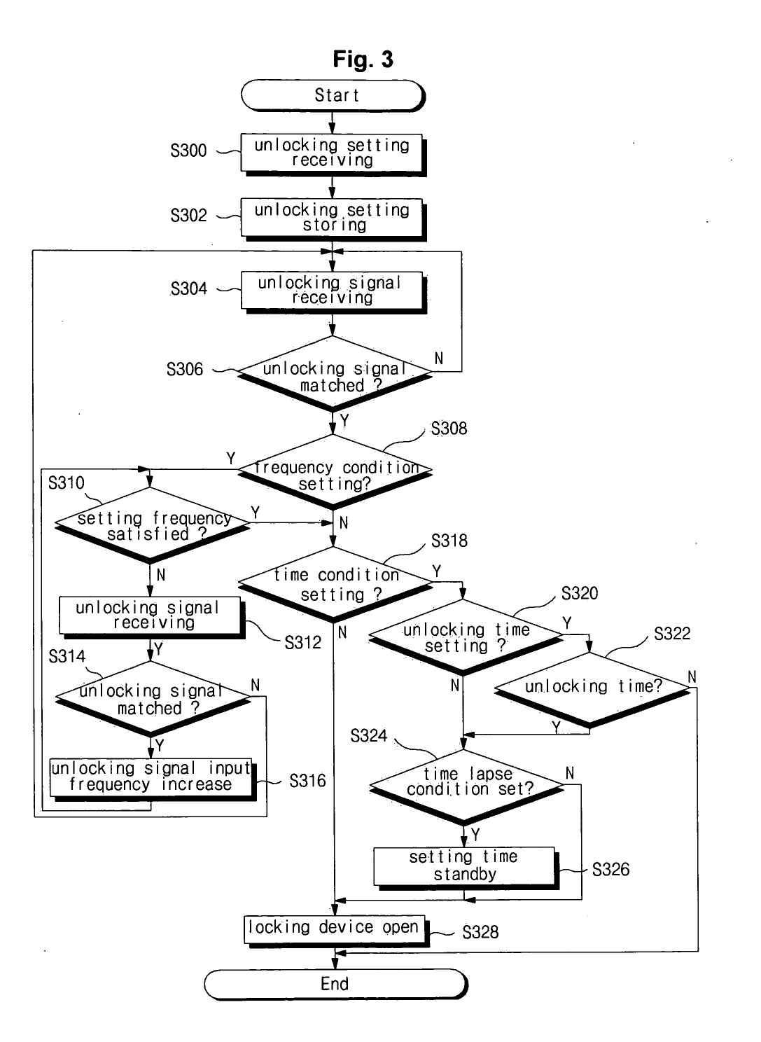

FIG. 3 is a flow chart of an operation of a locking and unlocking system for setting up an unlocking condition according to the present invention.

The operation of the unlocking condition setting type locking and unlocking system according to the present invention will be described with reference FIG. 3.

When the user first uses the unlocking condition setting type locking and unlocking system according to the present invention or the user inputs a setting unlocking signal and a setting unlocking condition by operating the input device 102 so as to change an unlocking setting including the setting unlocking signal and setting unlocking condition, the main control device 200 receives the unlocking setting (namely, setting unlocking signal and setting unlocking condition) outputted from the input device 102 and stores in the memory units 220 in steps S300 and S302. In the above steps, the inputted setting unlocking signal may be encrypted based on a certain algorithm and may be stored. When the setting unlocking signal is a video signal, a certain feature is extracted from the video based on a certain algorithm and is stored. When the user identification card is used based on the local area wireless communication, the serial number of the user identification card is stored as a setting unlocking signal.

When the user inputs an unlocking signal through the input device 102 so s to unlock the locked state of the locking and unlocking device 260, the main control device 200 receives an inputted unlocking signal in a step S304 and judges the coincidence between the received unlocking signal and the setting unlocking signal stored in the memory unit 220 in a step S306. In this process, when the setting unlocking signal is processed by a certain algorithm and is stored, the inputted unlocking signal is also processed based on the same algorithm, so that the coincidence is judged. When the inputted unlocking signal is coincided with the stored setting unlocking signal, the next step is performed. When the inputted unlocking signal is not coincided with the same, the locked state unlocking step is finished.

When the coincidence between the unlocking signal inputted in the step S306 and the stored setting unlocking signal is verified, the main control device performs a locked state unlocking step based on the next setting unlocking condition with reference to the setting unlocking condition stored in the memory unit 220.

The main control device 200 judges whether the unlocking signal input frequency condition is set or not in a step S308. When it is set, the locked state unlocking step based on the input frequency condition is performed.

It is judged whether the frequency, which the unlocking signal is inputted, satisfies the setting unlocking condition or not in a step S310.

When the frequency of the unlocking signal inputs does not reach the set frequency, the unlocking signal is received from the input device 102 in a step S312, and the coincidence of the unlocking signal is judged in a step S314. When the unlocking signals are matched, the frequency of the unlocking signal inputs is increased in a step S316, and it is judged whether the frequency of the unlocking signal inputs satisfies the stored setting unlocking condition in a step S310. As a result of the judgment, when the unlocking signal input frequency condition is not satisfied, the steps S312 to S310 are repeated. As a result of the judgment, when the unlocking signal input frequency condition is satisfied, the next locking state unlocking step is performed in a step S310.

Next, the main control device 200 judges whether the time condition is set as the setting unlocking condition. When the time condition is not set, the locked state of the locking and unlocking device 260 is unlocked in a step S328. When it is set, the locked state unlocking step is performed based on the time condition in a step S318.

When the time condition is set, it is judged whether the unlocking time is set or not in a step S320. When the unlocking time is set, it is judged whether the unlocking signal inputted through the input device 102 is inputted or not at the set unlocking time. As a result of the judgment, when the unlocking signal is inputted at the set unlocking time, the next step is performed. When the unlocking signal is inputted at the time different from the set unlocking time, the locked state unlocking step stops in a step S322.

When the unlocking time condition is not set or the unlocking time condition is satisfied, it is judged whether the time lapse condition is set or not in a step S324. As a result of the judgment, when the time lapse condition has been set, the locked state of the locking and unlocking system 260 is unlocked in a step S328 after the set time (S326) is passed. When the time lapse condition is not set, the locked state of the locking and unlocking device 260 is unlocked at that time, and the routine stops in a step S328.

The method of the unlocking condition setting type locking and unlocking system according to the present invention may include at least one step among the locked state unlocking steps which are performed based on the setting unlocking conditions, namely, the unlocking signal input frequency condition setting, the unlocking time condition setting, and the time lapse condition setting.

In addition, the method of the unlocking condition setting type locking and unlocking system according to the present invention is not limited to the locked state unlocking steps which are performed based on the setting unlocking conditions, namely, the unlocking signal input frequency condition setting, the unlocking time condition setting, and the time lapse condition setting. The method of the same may be performed in a random combination of the locked state unlocking steps based on each condition setting. Namely, the locked state unlocking step based on the unlocking time condition setting and time lapse condition and the time lapse condition setting may be first performed, and then the unlocking step based on the unlocking signal input frequency condition setting may be performed.

The unlocking condition setting type locking and unlocking system 100 is implemented through the above steps according to the present invention.

As described above, according to the locking and unlocking system for setting up an unlocking condition and a method thereof of the present invention, the locked state of the safe is unlocked when the previously setting unlocking conditions are satisfied except for inputting the previously set unlocking signal so as to unlock the locked state of the safe which stores cash or valuables. Therefore, it is possible to effectively protect the cash or valuables from robbery.

In addition, even when the unlocking signal is released to others, since the locked state is unlocked only when the unlocking conditions are satisfied, the security reliability is significantly enhanced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A locking and unlocking system for setting up an unlocking condition, comprising:
an input device which outputs a key control signal, a setting unlocking signal, a setting unlocking condition and an unlocking signal in accordance with a user's operation;
a main control device which receives and stores a setting unlocking signal and a setting unlocking condition outputted from the input device, receives an unlocking signal from the input device and compares the received unlocking signal with the stored setting unlocking signal for thereby judging whether the unlocking signals have a coincidence, and when the unlocking signals have a coincidence, it is judged whether the setting unlocking condition is satisfied or not, and when the setting unlocking condition is satisfied, the main control device outputs a locking unlocking signal;
a driving device which receives a locking unlocking signal from the main control device and unlocks the locked state; and
a locking and unlocking device in which the locking and unlocking state is changed based on an operation of the driving device.

2. The system of claim 1, wherein said main control device includes:
a memory unit which stores the setting unlocking signal and the setting unlocking condition outputted from the input device and operation programs for operating the locking and unlocking system;
A unlocking control unit which receives an unlocking signal from the input device, compares the received signal with the setting unlocking signal stored in the memory unit, and judges whether the unlocking signals have a coincidence, and when the unlocking signals are same, it is judged whether the setting unlocking condition stored in the memory unit is satisfied or not, and when the setting unlocking condition is satisfied, the unlocking control unit outputs a locking unlocking signal; and
a main control unit which controls the memory unit and the unlocking control unit in accordance with the operation program stored in the memory unit ands a key control signal outputted from the input device.

3. The system of claim 2, wherein said unlocking control unit includes:
an unlocking signal comparison module which receives an unlocking signal outputted from the input device and judges whether the received unlocking signal is matched with the setting unlocking signal stored in the memory unit; and
a time setting comparison module which judges the unlocking signal inputted through the input device is inputted at the unlocking time when the coincidence between the unlocking signal and the setting unlocking signal is verified by the unlocking signal comparison module, and the unlocking time is set as the setting unlocking condition stored in the memory unit, and when the unlocking signal is inputted at the unlocking time, the time setting comparison module outputs the locking unlocking signal.

4. The system of claim 2, wherein said unlocking control unit includes:
an unlocking signal comparison module which receives an unlocking signal outputted from the input device and judges whether the received unlocking signal is matched with the setting unlocking signal stored in the memory unit; and
a time setting comparison module which outputs a locking unlocking signal after a standby time corresponding to the time lapse condition is passed when the coincidence between the unlocking signal and the setting unlocking signal is verified by the unlocking signal comparison module, and the time lapse condition is set as the setting unlocking condition stored in the memory unit.

5. The system of claim 3, wherein said unlocking control unit further includes a setting frequency comparison module which compares the frequency of inputs of the unlocking signal inputted through the input device with the unlocking signal input frequency condition and outputs the locking unlocking signal when the unlocking signal is inputted by the same frequency as the unlocking signal input frequency condition, when the coincidence between the unlocking signal and the setting unlocking signal is verified, and the unlocking signal input frequency condition is set as the setting unlocking condition stored in the memory unit.

6. The system of claim 1, wherein said input device includes:
a key input unit for outputting a control signal based on a user's key input; and
an unlocking signal input unit which outputs an unlocking signal based on a user's operation.

7. The system of claim 1, wherein said unlocking condition setting type locking and unlocking system includes:
a display device which displays an operation state in accordance with a control of the main control device; and
a sound device which outputs a sound guide information, an operation sound and an alarm sound in accordance with a control of the main control device.

8. In a method of a locking and unlocking system having an input device and a locking and unlocking device, a method of a locking and unlocking system for setting up an unlocking condition, comprising:
a step (a) in which a setting unlocking signal and a setting unlocking condition inputted through the input device are received and stored;
a step (b) in which the unlocking signal inputted through the input device is received and compared with the setting unlocking signal for thereby judging a coincidence between the signals; and
a step (c) in which when the unlocking signal is coincided, it is judged whether the stored setting unlocking condition is satisfied or not, and when the setting unlocking condition is satisfied, the locked state of the locking and unlocking device is unlocked.

9. The method of claim 8, wherein said step (c) includes:
a step (c1.1) in which it is judged whether an unlocking signal input frequency condition is set or not among the setting unlocking conditions inputted in the step (a);
a step (c2.1) in which when the frequency condition is set, it is judged whether the unlocking signal of the setting input frequency is inputted or not;
a step (c3.1) in which as a result of the judgment of the step (c2.1), when the set input frequency is not reached, the unlocking signal inputted through the input device is received, and the coincidence of the unlocking signals is judged, and when the signals are coincided, the frequency of the inputs of the unlocking signal is increased, and the routine returns to the step (c1.1); and
a step (c4.1) in which when the set input frequency reaches as a result of the judgment in the step (c2.1), the locked state of the locking and unlocking device is unlocked.

10. The method of claim 8, wherein said step (c) includes:
a step (c1.2) in which it is judged whether an unlocking time condition is set or not among the setting unlocking conditions inputted in the step (a);
a step (c2.2) in which when the unlocking time condition is set, it is judged whether the unlocking signal is inputted or not at the set unlocking time;
a step (c3.2) in which as a result of the judgment of the step (c2.2), when the unlocking signal is inputted at the set unlocking time, the locked state of the locking and unlocking device is unlocked, and when the unlocking signal is not inputted at the set unlocking time, the routine is finished.

11. The method of claim 8, wherein said step (c) includes:
a step (c1.3) in which it is judged whether a time lapse condition is set or not among the setting unlocking condition inputted in the step (a); and
a step (c2.3) in which when a time lapse condition is set, the locked state of the locking and unlocking device is unlocked after the time based on the time lapse condition is passed.
